(19) United States
(12) Patent Application Publication
(10) Pub. No.: US 2006/0201777 A1
(43) Pub. Date: Sep. 14, 2006

(54) Trailer having an endless conveyor

(76) Inventors: John A. Michel, Oshawa (CA); Robert W. Michel, Oshawa (CA)

Correspondence Address: BUTZEL LONG, 350 SOUTH MAIN STREET, SUITE 300, ANN ARBOR, MI, 48104, US

(21) Appl. No.: 11/075,067

(22) Filed: Mar. 8, 2005

(51) Int. Cl. B65G 65/02

(52) U.S. Cl. 198/311

(57) ABSTRACT

A trailer having an endless conveyor is provided. The trailer comprises a support frame, and a load supporting floor having opposed first and second ends, the floor being disposed above the support frame. A pair of opposed sidewalls extend upwardly from lateral sides of the floor. A first roller positioned towards the first end of the floor and a second roller positioned towards the second end of the floor. An endless belt extends about the floor and the first and second rollers such that an upper portion of the belt passes over the floor and a lower portion of the belt extends below the floor. The belt has sufficient elasticity to frictionally engage the first and second rollers. A drive mechanism is coupled to the first roller for rotating the first roller and causing travel of the belt. A tensioning mechanism for maintaining a relatively constant belt tension during travel of the belt is also provided. The tensioning mechanism is operably connected between one of the first or second rollers and the support frame to move the one first or second roller relative to the other of the first or second rollers so as to adjust the tension of the belt. Other embodiments of a trailer having an endless conveyor are also provided.

### FIELD OF THE INVENTION

The present invention relates to a trailer for a truck or tractor, and more particularly a trailer having an endless conveyor.

### BACKGROUND OF THE INVENTION

Live-bottom trailers are trailers having an endless conveyor that may be used to unload materials within the trailer. One type of live-bottom trailer includes a length of roller chain extending along each side of the trailer with attached cross-members extending therebetween, and a belt fastened to the top of the chain. Another type of live-bottom trailer includes roller chains, and a belt that surrounds but is not fastened to the chain. In this type of live-bottom trailer, the roller chain is driven and the weight of the load material on the belt maintains frictional contact between the chain and the belt that is sufficient to cause travel of the belt as the chain is rotated.

The use of roller chains and cross-members has several drawbacks. Firstly, roller chains are prone to breakage, particularly pin breakage. When chain breakage occurs, the load carried by the trailer must be removed manually. Roller chains are also prone to the adverse affects of salt and sand kicked up from the road, and from contamination by load material that may fall between the belt and sidewalls. Other problems with a chain drive include the frequent maintenance required to keep the roller chain tight, wear of the drive gears, wear of cross-members and/or their support mechanisms, bending of cross-members, and leakage of product through the side seals and in the area between cross-members. Roller chains also typically require continuous lubrication or oiling. Lubrication of the chains is costly and may result in oil dripping on the road, which is an environmental concern.

The load capacity of these types of live-bottom trailer is also limited by the strength of the cross-members. This typically means that the trailer may only be used to move light or small aggregate materials. Further, the conveyor belt stretches resulting in a “wash-boarding” effect in which belt material droops or sags between cross-members where the belt is fastened to the roller chain. Wash-boarding results in increased material leakage and uneven wear of the belt.

Another type of live-bottom trailer uses a conveyor belt that travels over a solid floor of the trailer. While effective, known live-bottom trailers of this type suffer from several drawbacks. Firstly, this type of the live-bottom trailer typically does not provide proper tensioning of the belt. Poor tensioning causes belt slippage and a loss of traction which typically results in poor unloading ability. In some cases, poor tensioning may result in a total loss of traction and drive capability, necessitating manual unloading of the trailer. Further, this type of live-bottom trailer often experiences problems associated with tracking of the belt. Tracking of the belt is important for proper operation of the conveyor and good unloading ability.

Thus, there remains a need for an improvement in trailers having an endless conveyor.

### SUMMARY OF THE INVENTION

The present invention provides a trailer having an endless conveyor that seeks to provide improved unloading ability and/or improved load capacity. In some embodiments, the trailer includes a tensioning mechanism for maintaining a relatively constant belt tension during travel of the belt. In some embodiments, the trailer allows the belt tension to be adjusted during operation of the trailer. In some applications, the trailer provides improved traction between the driven roller and the belt, improving the power transfer from the drive mechanism to the belt. In yet other embodiments, the trailer provides improved guiding and tracking of the belt.

According to one example of the present invention, there is provided a trailer for a truck or tractor, comprising: a support frame; a load supporting floor having opposed first and second ends, the floor being disposed above the support frame; a pair of opposed sidewalls extending upwardly from lateral sides of the floor; a first roller positioned towards the first end of the floor and a second roller positioned towards the second end of the floor; an endless belt extending about the floor and the first and second rollers such that an upper portion of the belt passes over the floor and a lower portion of the belt extends below the floor, the belt having sufficient elasticity to frictionally engage the first and second rollers; a drive mechanism coupled to the first roller for rotating the first roller and causing travel of the belt; and a tensioning mechanism for maintaining a relatively constant belt tension during travel of the belt, the tensioning mechanism being operably connected between one of the first or second rollers and the support frame to move one first or second roller relative to the other of the first or second rollers so as to adjust the tension of the belt.

According to another example of the present invention, there is provided a trailer for a truck or tractor, comprising: a support frame; a load supporting floor having opposed first and second ends, the floor being disposed above the support frame; a pair of opposed sidewalls extending upwardly from lateral sides of the floor; a first roller positioned towards the first end of the floor and a second roller positioned towards the second end of the floor; an endless belt extending about the floor and the first and second rollers such that an upper portion of the belt passes over the floor and a lower portion of the belt extends below the floor, the belt having sufficient elasticity to frictionally engage the first and second rollers; a drive mechanism coupled to the first roller for rotating the first roller and causing travel of the belt; and a pair of extensible cylinders, each cylinder operably connected between the second roller and a lateral side portion of the support frame for moving the second roller relative to the first roller along an axis generally parallel to a direction of the floor so as to adjust the tension of the belt.

According to a further example of the present invention, there is provided a trailer for a truck or tractor, comprising: a support frame; a load supporting floor having opposed first and second ends, the floor being disposed above the support frame; a pair of opposed sidewalls extending upwardly from lateral sides of the floor; a first roller positioned towards the first end of the floor and a second roller positioned towards the second end of the floor; an endless belt extending about the floor and the first and second rollers such that an upper portion of the belt passes over the floor and a lower portion of the belt extends below the floor, the belt having sufficient elasticity to frictionally engage the first and second rollers; a drive mechanism operably connected to the first roller for rotating the first roller and causing travel of the belt; and an idler roller positioned opposite the first roller such that the belt wraps around the first roller and the idler roller to provide a contact area between the belt and the first roller for reducing slippage of the belt.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention, and in which:

FIG. 1 is a perspective view of one embodiment of a trailer having an endless conveyor according to the present invention;

FIG. 2 is a sectional side view of the trailer of FIG. 1;

FIG. 3 is a sectional front view of the trailer of FIG. 1;

FIG. 4 is a sectional rear view of the trailer of FIG. 1;

FIG. 5 is a side view of one embodiment of a drive mechanism for a trailer having an endless conveyor according to the present invention;

FIG. 6 is a side view of one embodiment of a tensioning mechanism for a trailer having an endless conveyor according to the present invention;

FIG. 7A is a schematic diagram showing one embodiment of a hydraulic system for a trailer having an endless conveyor according to the present invention;

FIG. 7B is a schematic diagram showing another embodiment of a hydraulic system for a trailer having an endless conveyor according to the present invention;

FIG. 8 is a sectional view of one embodiment of a driven roller;

FIG. 9 is a schematic diagram of the trailer showing guiding and tracking mechanisms;

FIG. 10 is a partial sectional view of one embodiment of a guide mechanism for the upper portion of the belt;

FIG. 11A is a top view of one embodiment of a guide mechanism for the lower portion of the belt;

FIG. 11B is a sectional view of the guide mechanism of FIG. 11A showing the first and second members; and

FIG. 12 is an end view of one embodiment of a guide mechanism for a driven roller.

Similar references are used in different figures to denote similar components.

### DETAILED DESCRIPTION OF THE DRAWINGS

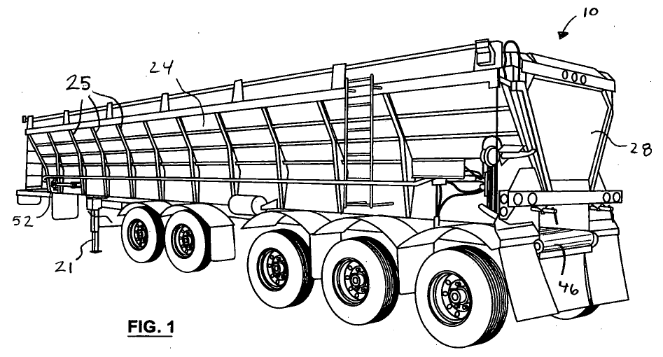

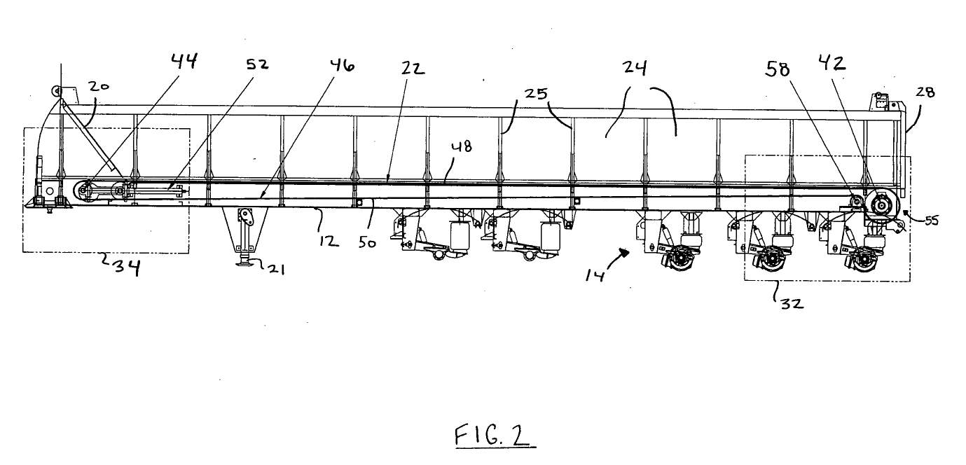

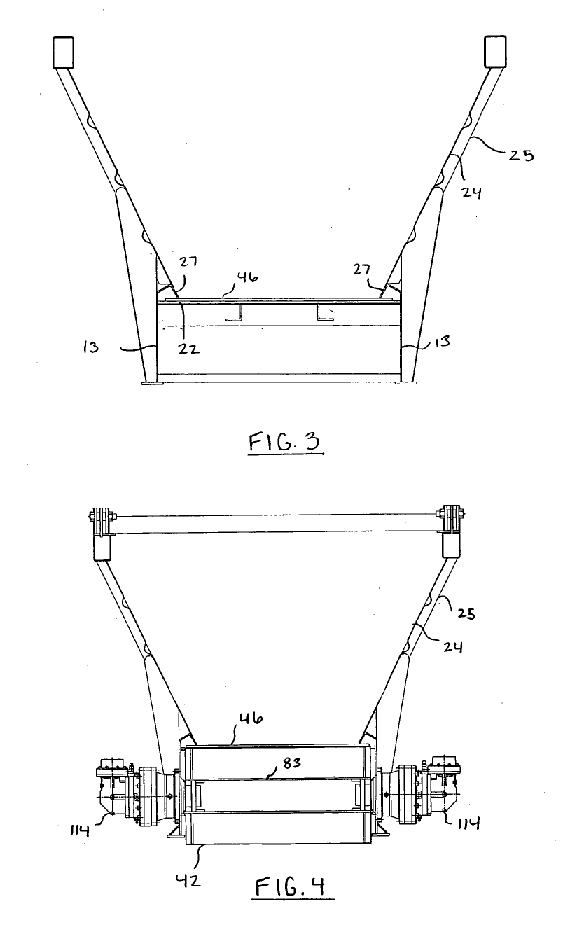

Reference is first made to FIG. 1 to 4 which show a trailer 10 for a truck or tractor according to one example embodiment of the present invention. The trailer 10 has a body comprising a support frame 12, an undercarriage indicated generally by the reference 14, and a trailer body. The trailer body includes a front wall 20, a load supporting floor 22 disposed above the support frame 12, a pair of opposed sidewalls 24 extending upwardly from lateral sides of the floor 22, and a tailgate 28.

The support frame 12 may comprise a pair of side rails having lateral side plates 13. Cross-members may extend through or between the side rails. In the shown embodiment, support arms 21 are attached to and extend downwardly from lateral sides of the support frame 12. The floor 22 is generally planar and has opposed first and second ends indicated by references 32 and 34 respectively. In the shown embodiment, the first end 32 of the floor is positioned near the rear of the trailer 10 and the second end 34 is positioned near the front of the trailer 10. The floor 22 is constructed of steel or other suitable material selected according to the impact tolerance required by the type of load to be carried and the method of loading to be used. In one embodiment, the floor 22 is constructed of stainless steel. In other embodiments, the floor 22 may be constructed from T1 plate, mild steel or aluminum. In some embodiments, the floor may be overlayed with a protective covering such as a plastic liner.

In the shown embodiment, the sidewalls 24 are pitched or inclined to facilitate feeding of material into the trailer 10. The angle of inclination of the sidewall 24 may vary between different embodiments according to the requirements of the particular application of the trailer 10. In some embodiments, vertical sidewalls 24 may be used. The height of the sidewalls 24 may also be varied according to the requirements of the particular application. The sidewalls 24 may also include a plurality of equally spaced strengthening ribs 25. The undercarriage 14 may be any conventional undercarriage for a live-bottom trailer. The tailgate 28 may be pivotally coupled to an upper rear portion of the sidewalls 24 allowing it to be swung open and closed.

A first roller 42 is positioned towards the first end 32 of the floor 22. A second roller 44 is positioned towards the second end 34 of the floor 22. An endless belt 46 made of a stretchable resilient material extends about the floor 22 and the first and second rollers 42 and 44 such that an upper portion 48 of the belt 46 passes over the floor 22 and a lower portion 50 of the belt 46 extends below the floor 22. The belt 46 has sufficient elasticity to frictionally engage the first and second rollers 42 and 44. The first and second rollers 42, 44 are typically positioned such that the top surface of the rollers is level with the top surface of floor 22. The belt 46 is typically provided with ½″ of clearance or more between the edges of the belt 46 and the sidewalls 24.

The thickness and construction of the belt 46 may be varied according to the particular application of the trailer 10 and the material being loaded. For example, the belt 46 may be selected to withstand the stresses of heavy loads and/or resist the effects of adverse weather conditions. In some embodiments, the belt 46 may be selected to withstand high temperatures of hot materials such as hot asphalt. In some applications the thickness of the belt 46 ranges between 5/16″ and ¾″, and may be comprised of a number of layers which are bonded together (e.g. 2 ply or 4 ply).

Longitudinal seals 27 may be attached along lower inside edges of the sidewalls 24 to reduce the leakage of material from the trailer 10. In some embodiments, the longitudinal seals 27 may extend inwardly over the upper belt portion 48. The weight of the load material pressing against the inwardly extending portion may improve the quality of the seal. The trailer 10 may also include transverse seals (not shown) extending along bottom edges of the front wall 20 and the tailgate 28.

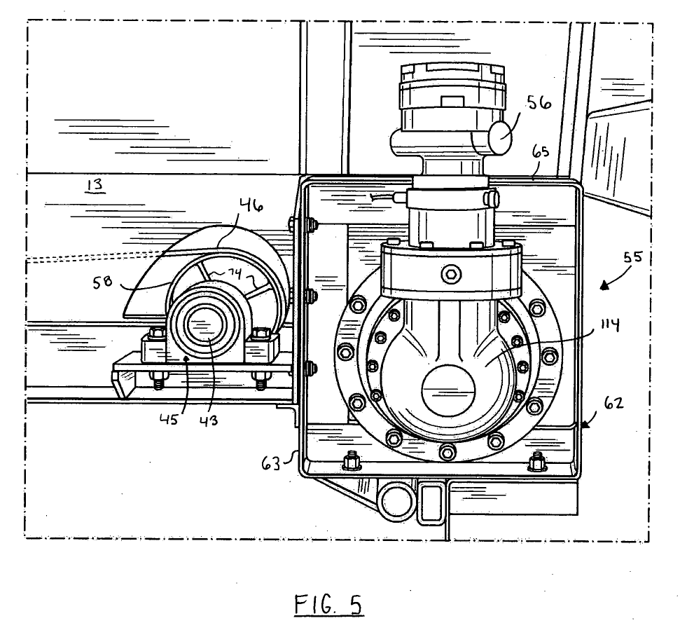

A drive mechanism or drive 55 is coupled to the first roller 42 for rotating the first roller 42 and causing travel of the belt 46. As shown in FIG. 5, in one embodiment the drive mechanism 55 comprises a rotating mechanism such as a motor 56 operably connected to the first roller 42 for rotating the first roller 42 and causing travel of the belt 46, and a snubber or idler roller 58. The idler roller 58 is positioned horizontally opposite the first roller 42 such that the belt 46 extends about the first roller 42 and the idler roller 58 to provide a contact area between the belt 46 and the first roller 42 for reducing slippage of the belt 46. The idler roller 58 increases the contact area and frictional contact pressure between the belt 46 and the first roller 42, improving traction and allowing more power to be transferred to the belt 46. In some embodiments, the drive mechanism 55 comprises a pair of motors 56 located on opposite sides of the trailer 10, each motor 56 being operably connected to the first roller 42 for rotating the first roller 42 and causing travel of the belt 46.

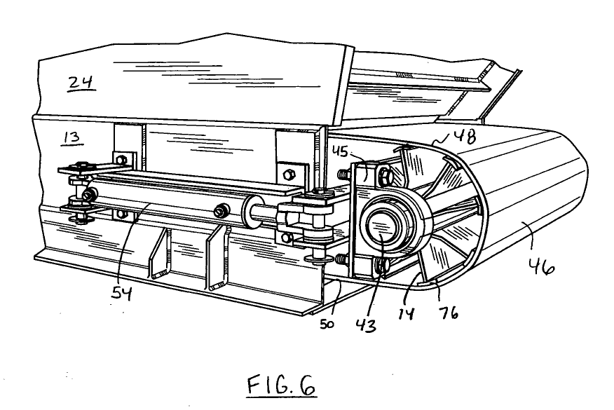

In the shown embodiment, the belt 46 wraps around the first roller 42 and idler roller 58 in a generally S-shaped manner. The idler roller 58 is positioned such that the belt 46 contacts at least 50 percent of an outer surface of the first roller 42. The idler roller 58 is typically positioned so that the belt 46 contacts between 60 and 85 percent of the outer surface of the first roller 42. In some embodiments, the belt 46 contacts at least 70 or 75 percent of an outer surface of the first roller 42. As shown in FIGS. 5 and 6, the second roller 44 and idler roller 58 may include a central shaft 43 passing through the respective axis of rotation of each of the rollers 44, 58. The shafts 43 are rotatably supported at opposite ends thereof by bearings 45 attached to the lateral side plates 13 of the support frame 12.

In the shown embodiment, the first roller 42 is a drive drum having a relatively large diameter compared to that of the second roller 44. In some example embodiments, the first roller 42 has a diameter ranging between 18″ and 42″ depending on the particular application (larger diameters for more heavy duty applications) and the second roller 44 has a diameter of 12″. The first roller 42 may be provided with a traction coating for improving the frictional contact between the first roller 42 and the belt 46, and thereby improving the traction of the first roller 42. In some embodiments, the first roller 42 has a diamond cut traction coating having a thickness of ⅜″, and a durometer rating (hardness) of 60.

A tensioning mechanism 52 is operably connected between the second roller 44 and the support frame 12 to move the second roller 44 relative to the first roller 42 so as to adjust the tension of the belt 46. In the shown embodiment, the tensioning mechanism 52 comprises a pair of extensible cylinders 54, each cylinder being operably connected between the second roller 44 and a lateral side portion of the support frame 12. The cylinders 54 may be pneumatic or hydraulic cylinders. In some embodiments, the cylinders 54 maintained at a relatively constant pressure. In the shown embodiment, the cylinders 54 are externally mounted on the lateral support plates 13. In the shown embodiment, the tensioning mechanism 52 moves the second roller 44 relative to the first roller 42 along an axis generally parallel to a direction of the floor 22. Typically, the tensioning mechanism 52 is located at the same end as the front wall 20 so that when the cylinders 54 are retracted, the second roller 44 is positioned close to the front wall 20. In such embodiments, when the cylinders 54 are extended, the second roller 44 will move beyond the front wall 20 where the floor 22 typically ends. This reduces or eliminates portions of the belt 46 which may be unsupported by the floor 22. In other embodiments, the tensioning mechanism 52 may be located at the same end as the tailgate 28 if desired.

In some embodiments, the floor 22 extends in a generally horizontal direction and the tensioning mechanism 52 moves the second roller 44 relative to the first roller 42 in a generally horizontal direction generally parallel to the direction of the floor 22.

During the operation of the trailer 10, the belt 46 may stretch under load. Excessive belt stretch may result in belt slippage and a loss of traction. Belt stretch may be significant in some applications. For example, in a typical application where the load material is an aggregate, the belt 46 may stretch 3 to 4 inches. In applications where the load material is a hot product such as asphalt, the belt 46 may stretch up to 3 to 4 feet. The tensioning mechanism 52 may be used for maintaining a relatively constant belt tension during travel of the belt 46 by taking up belt stretch. The necessary belt tension is a process parameter that varies between applications and can be readily determined by a person skilled in the art.

By maintaining a relatively constant tension, the frictional contact between the first roller 42 and the belt 46 is held relatively constant, thereby reducing or eliminating any belt slippage, loss in traction, or loss in power transfer due to belt stretch. In some embodiments, the tensioning mechanism 52 is responsive to a stretch of the belt 46 such that the tension of the belt 46 is adjusted in response to the belt stretch. For example, the tensioning mechanism 52 may be responsive to an operating stretch of the belt. Operating stretch refers to the stretch of the belt 46 in an operating condition. The operating stretch may vary during the operation of the trailer. The operating stretch at any given time depends on the prevailing operating conditions, including the load and the speed of the belt 46.

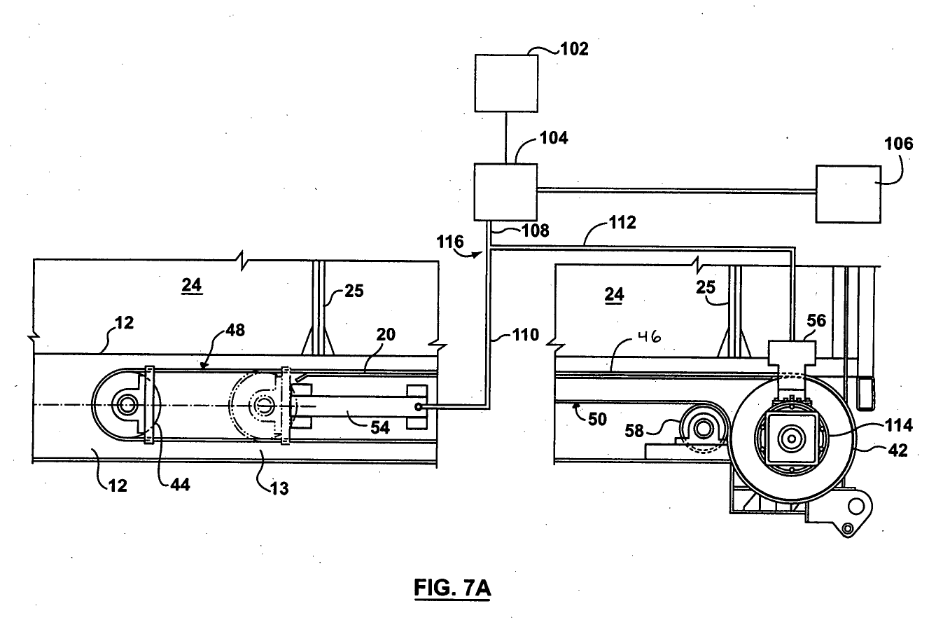

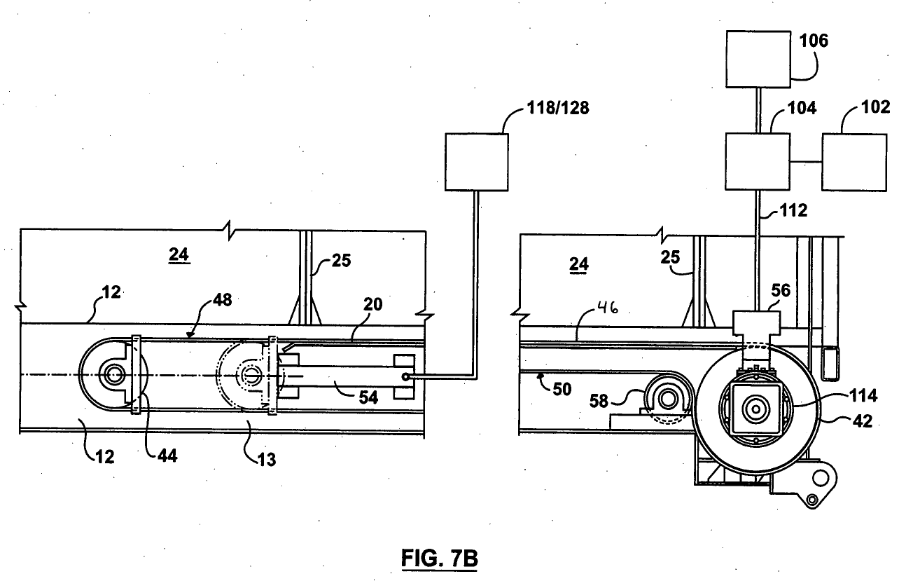

Referring to FIG. 7A, a hydraulic system for a trailer 10 having a hydraulic drive mechanism will be described. In the shown embodiment, the cylinders 54 are hydraulic cylinders and the motor 56 is a hydraulic motor. A power source 102 is connected to and powers a hydraulic pump 104. The power source 102 may be, for example, a power take-off from a truck or tractor connected to the trailer 10 or a separate electric motor. The hydraulic pump 104 pumps hydraulic fluid from a reservoir 106 through hydraulic lines 108, 110, 112 to actuate the hydraulic motor and the hydraulic cylinders.

A speed reducer or torque intensifier 114 is provided to reduce the speed at which the hydraulic motors operate to a useful range for driving the belt 46, and increase the power and torque applied to the first roller 42. In the shown embodiment, the hydraulic motor 56 is operably connected to a planetary reduction drive for reducing the axial frequency at which the first roller 42 rotates. Planetary reduction drives are relatively compact, reliable, durable, consistent and economical. The use of a planetary reduction drive allows the rate of rotation of the first roller 42 to be reduced without the complications presented by gears and chains. Other types of torque intensifier 114 may be used in different embodiments.

In the shown embodiment, the hydraulic cylinders and the hydraulic motor are fed from a common hydraulic line 108 providing automatic adjustment of the tension of the belt 46 as pressure in the hydraulic line is increased to rotate the first roller 42 at a desired speed. In the shown embodiment, a splitter or “T” fitting 116 splits the hydraulic fluid between the hydraulic cylinders and the hydraulic motor via hydraulic lines 110 and 112 respectively. As hydraulic pressure in the line 108 is increased (for example, because increased hydraulic pressure is required to drive the first roller 42 and move the load material) the hydraulic pressure in the line 110 to the cylinders is similarly increased.

The operating stretch of the belt 46 typically increases and decreases with the load of the trailer, thus if the load increases or an increase speed of the belt 46 is desired, the tensioning mechanism 52 takes up any additional stretch and allows the tension of the belt 46 to be adjusted without the use of measurement devices and control systems. Conversely, if the load is decreased the tensioning mechanism 52 automatically adjusts the tension of the belt 46 to prevent over-tensioning while maintaining the necessary frictional contact on the first roller 42.

Various modifications and adaptations of the automatic hydraulic tensioning system are possible. As shown in FIG. 7B, in some example embodiments, one or more hydraulic accumulators 118 are used instead of coupling the hydraulic cylinders and hydraulic motor(s). In the shown embodiment, the hydraulic cylinders are coupled to a hydraulic accumulator 118 which is preloaded to the required hydraulic pressure. In some embodiments, a gas-loaded hydraulic accumulator also known as a hydropneumatic accumulator may be used. A bladder-type accumulator is an example of suitable gas-loaded hydraulic accumulator that may be used. The gas-loaded accumulator comprises a fluid compartment and a gas compartment (e.g. nitrogen). The fluid compartment is connected to the hydraulic system of the trailer 10 so that as pressure rises, hydraulic fluid enters the accumulator and the gas compresses. As pressure in the system falls, the compressed gas expands and forces the stored hydraulic fluid back into the system.

According to another variation, in some embodiments the hydraulic cylinders are coupled to a hydraulic intensifier or booster 128 that can deliver additional hydraulic fluid and increase the fluid pressure on demand. In other embodiments, the hydraulic cylinders are operated using hydraulic preloading (e.g. at 400 psi) which typically requires a more complicated hydraulic system. In yet other embodiments, the trailer 10 may include a measuring device for measuring the tension of the belt 46, and a controller operably connected to the measuring device and the tensioning mechanism 52 to adjust the tension of the belt in response to the measured tension.

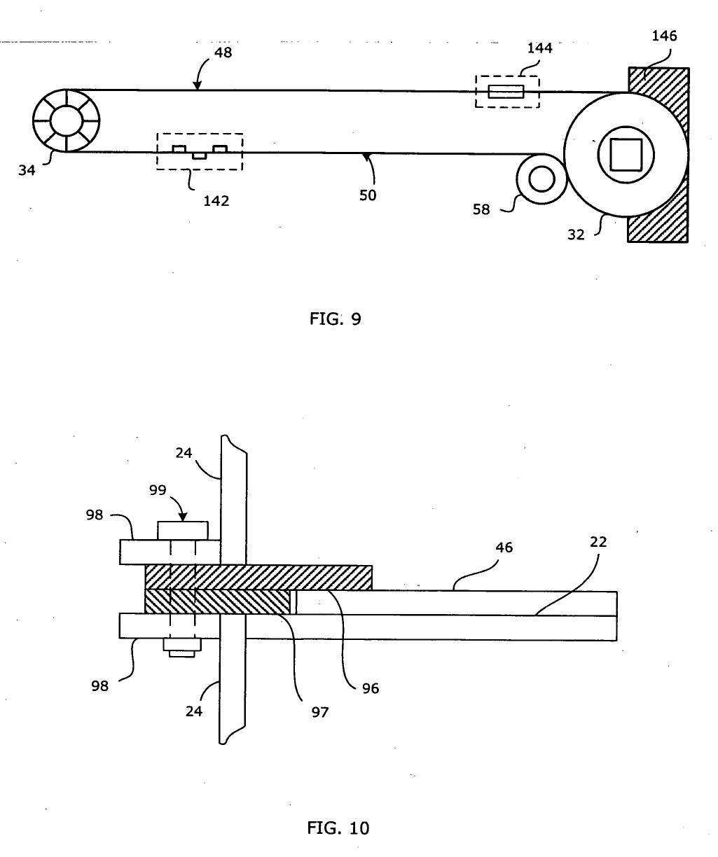

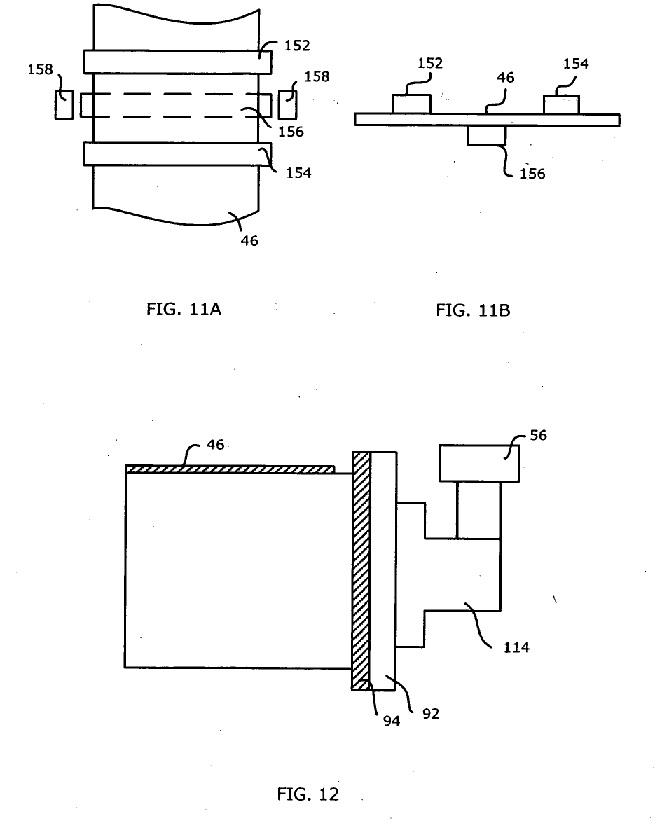

FIG. 9 shows several guide and tracking mechanisms for the belt 46. In the shown embodiment, the trailer 10 includes a first guide mechanism 142 for the lower belt portion 50, a second guide mechanism 144 for the upper belt portion 48, and a third guide mechanism 146 for the driven roller. As shown more fully in FIGS. 11A and 11B, the guide mechanism 142 holds the lower belt portion 50 relatively flat as it approaches the second roller 44. The guide mechanism 142 is positioned towards the second roller 44, and includes upper and lower portions extending inwardly from (or between) lateral side portions of the support frame 12. The belt 46 extends between the upper and lower portions extending inwardly from lateral side portions of the support frame 12. In some embodiments, the guide mechanism 142 may only include an upper portion.

In the embodiment shown in FIGS. 11A and 11B, the first guide mechanism 142 comprises a pair of horizontally spaced apart first members 152 and 154 extending between lateral side portions of the support frame 12. The first guide mechanism 142 also comprises a second member 156 extending between the lateral side portions of the support frame 12. The first members 152, 154 are positioned on one side of the lower belt portion 50. The second member 156 is vertically positioned on the opposite side of the lower belt portion 50, and is horizontally positioned between the first members 152 and 154 respectively. In the shown embodiment, the first members 152 and 154 are located above the belt 46 and the second member 156 is located below the belt 46, however this orientation may be reversed if desired.

The first guide mechanism 142 may also comprise a pair of vertical extending members 158 positioned on opposite sides of the belt 46, each of the vertically extending members 158 being horizontally positioned between the first members 152 and 154 respectively. The vertically extending members 158 allow the tracking of the belt 46 to be adjusted by directing the edges of the belt 46 away from the sidewalls 24 should the belt 46 be tracking in that direction. The vertically extending members 158 may be horizontally aligned with the second members 156 as shown in FIGS. 11A and 11B. In some embodiments, the second members 156 and/or vertically extending members are centered between the first members 152 and 154 respectively.

The first guide mechanism 142 may be adapted to move with the second roller 44 in response to changes in position of the second roller 44 due to adjustments of the tensioning mechanism 52. For example, the first guide mechanism 142 may be operably connected to the tensioning mechanism 52 or second roller 44 to move the guide mechanism 142 relative to the first roller 42 such that relatively constant distance between the second roller 44 and the guide mechanism 142.

Although in the shown embodiment the belt 46 approaches the first guide mechanism 142 horizontally, in other embodiments the belt 46 may approach the first guide mechanism 142 at an angle. Typically, the first guide mechanism 142 is positioned close to the second roller 44 so that the most benefit may be derived from the horizontal approach of the belt 46 provided by the mechanism 142. Further, although in the shown embodiment the first, second members are vertically extending members are cross-members, in other embodiments rollers may be used instead of cross-members or the like.

Referring now to FIG. 10, the second guide mechanism 144 will be described in more detail. A second guide mechanism 144 is provided on each side of the trailer 10. The second guide mechanism 144 holds the upper belt portion 48 relatively flat as it approaches the first roller 42. The guide mechanism 144 is positioned towards the first roller 42, and includes a first portion 96 extending inwardly from lateral side portions of the support frame 12 for holding the upper belt portion 48 in contact with the floor 22. Although not shown, the floor 22 may have a protective liner. The guide mechanism 144 may also include a second portion 97 such as a spacer plate positioned opposite an edge of the belt 46. The second portion 97 adjusts the tracking of the belt 46 by directing the edges of the belt 46 away from the sidewalls 24 should the belt 46 be tracking in that direction. In the shown embodiment, the guide mechanism 144 is secured to a pair of end plates 98 extending from the support frame 12 using fasteners 99 extending therethrough. The fasteners 99 may be bolts or other suitable fasteners. Typically, the second guide mechanism 144 is positioned close to the first roller 42 to derive the most benefit from the guiding and tracking provided by the mechanism 144.

The first and second portions 96 and 97 may be formed as separate pieces as shown in FIG. 10, or may be formed as a single piece of material. In some embodiments, first and second portions 96 and 97 are formed from plastic. In some embodiments, for example where the width of the belt 46 is similar to or the same as the width of floor 22, the section portion 97 (e.g. spacer plate) of the guide mechanism 144 may not be necessary or desired.

Referring now to FIG. 12, the third guide mechanism 146 will be described in more detail. The guide mechanism 146 comprises a pair of wear plates or guard plates 94 positioned on opposite ends of the driven roller e.g. first roller 42. The guard plates 94 are positioned on the outer side of the first roller 42 where the belt 46 extends about the roller 42. The guard plates 94 are positioned between the first roller 42 and the mounting plate 92 of the motor 56 or torque intensifier 114, depending on the particular embodiment. In some embodiments, the guard plates 94 are made from plastic. The guard plates 94 partially fill the gap between the first roller 42 and motor 56 or torque intensifier 114, preventing the belt 46 from slipping off the ends of the roller 42 into the gap, and adjusting the tracking of the belt 46 about the first roller 42 by directing its edges away from the plates 94 should the belt 46 tracking in that direction.

As shown in FIG. 5, the drive mechanism 55 is mounted to the trailer 10 using mounting plates or mounting assemblies 62 on opposite sides of the trailer 10. One or more vertically extending-tracking plates (not shown) may be positioned between a side portion 63 of the mounting plates 62 and the support frame 12 to provide selective adjustment of the tracking of the belt 46. The addition/removal of the vertically extending tracking plates allows horizontal adjustment of the tracking or alignment of the belt 46. One or more horizontally extending tracking plates (not shown) may be positioned between an upper portion 65 of the mounting plates 62 and the support frame 12 to adjust the vertical position of the first roller 42, for example, so that the top surface of the rollers is level with the top surface of floor 22. The addition/removal of the horizontally extending tracking plates allows vertical adjustment of the position of the first roller 42. This configuration allows vertical and horizontal adjustment to be performed at any time.

Referring now to FIG. 6, a hollow roller construction for use in the idler roller or second roller will be described. In the shown embodiment, the second roller 44 comprises a central shaft 43 and a plurality of spaced apart radially extending fins 74. The fins are typically evenly spaced. Endplates 76 are attached to the ends of each fin 74. The endplates 76 form a series of contact or pressure points that maintain frictional contact between the second roller 44 and the belt 46. In the shown embodiment, the endplates 76 are slightly V-shaped forming an apex or peak directed towards the belt 46. In some applications, the hollow configuration of the rollers may provide self-cleaning action by allowing material which was not caught by the seals to escape through the space between fins 74.

In other embodiments, the idler roller or second rollers may have a hollow configuration having a continuous outer surface which extends about the fins 74 and contacts the belt 46 rather than using endplates 76. For example, in some embodiments the rollers may have a generally cylindrical outer surface that extends circumferentially about the ends of the fins 74.

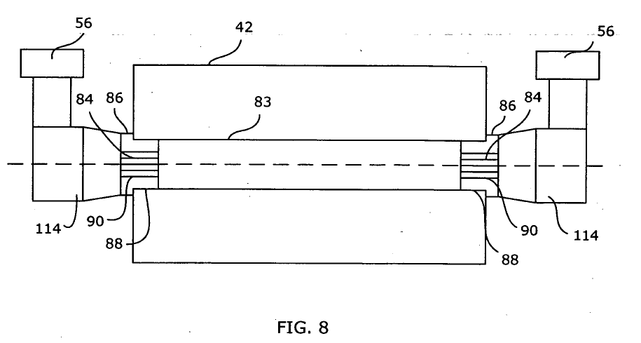

Referring to FIG. 8, one embodiment of the first roller 42 will be described in more detail. In the shown embodiment, the first roller 42 is mounted to a fine tooth splined drive shaft 84 using a mounting collar 86. The drive shaft 84 has first and second splined ends, the first splined end being operably coupled to the motor 56 for example via the torque intensifier 114. The first roller 42 defines a central passage or bore 83 extending therethrough. The mounting collar 86 has a first portion 88 for mounting to the first roller 42 and a second portion 90 for mounting to the shaft 84. The first portion 88 of the mounting collar 86 is shaped to match the shape of the central passage 83. The second portion 90 defines a splined portion for mounting to the second splined end of the shaft 84. In the shown embodiment, the central passage 83 of the first roller 42 has a polylateral shaped cross-section (e.g. rectangular or square shaped) and the first portion 88 of the mounting collar 86 has a matching polylateral shaped cross-section. The mounting of the first roller 42 to a fine tooth splined shaft in this manner allows some deflection in the alignment of the roller 42 without creating significant stress.

As shown in FIG. 5, in some embodiments the second roller 44 and tensioning mechanism 52 are mounted at the end of the trailer 10. However, in other embodiments the second roller 44 and tensioning mechanism 52 may be inset from the end (e.g. front) of the trailer 10. In such embodiments, the support frame 12 defines lateral openings or cutouts in the lateral side plates 13 so that the ends of the second roller 44 may extend thererthrough. For the proper operation of the tensioning mechanism 52, the cutouts should be at least as long as the extensible range of the cylinders 54. In such cases, the central shaft 43 of the second roller 44 is rotatably supported at opposite ends by bearings 45 in a similar manner to that described above.

The typical operation of a trailer having an endless conveyor according to the present invention will now be briefly described. The trailer may be loaded with a material to be carried using conventional means such as conveyor belts or industrial loaders. The trailer may be used to carry and unload a variety of different materials including light and heavy aggregate, large rocks, stones and other awkward objects, mine tailings, and hot asphalt mix. The weight of the load within the trailer is supported by the load supporting floor. The trailer may be connected to a truck or tractor for transportation. After being transported to a desired location for unloading, the belt may be activated by an operator while fully laden with the load in direct contact with the conveying belt. The requisite belt tension may be maintained by using an automatic tensioning mechanism such as, for example, extensible cylinders which may be coupled to system hydraulics.

The present invention, depending on the particular embodiment, may provide several advantages including a heavy duty solid floor construction allowing heavy loads such as large aggregate and stones to be carried, a sealed floor system to reduce or eliminate leakage of material, reduced trailer weight, elimination of gears and chains and their inherent drawbacks, relatively smooth belt and load movement, and lower costs and times for belt service and replacement. Another advantage, in some embodiments, is that a built-in safety mechanism is provided by the way of drum slippage. If power is increased and the load is still unable to move, the belt 46 will slip over the first roller rather than damaging any system component. Unlike other configurations, drum slippage provides the operator with an opportunity to correct the problem or condition preventing the load from moving (e.g. overloading) before damage to the system occurs. A further advantage, in some embodiments, is that the tensioning mechanism may be used to automatically adjust belt tension in response to the stretch of the belt. Conventional pre-tensioning systems over-tension the belt prior to operation to compensate for belt stretch when under load. Pre-tensioning systems typically result in over or under-tensioning of the belt, and do not provide the ability to adjust belt tension during operation to adapt to changes in belt stretch.

According to another embodiment of the present invention, there is provided a trailer for a truck or tractor, comprising: a support frame; a load supporting floor having opposed first and second ends, the floor being disposed above the support frame; a pair of opposed sidewalls extending upwardly from lateral sides of the floor; a first roller positioned towards the first end of the floor, the first roller defines a central passage therethrough; a second roller positioned towards the second end of the floor; an endless belt made of a stretchable material extending about the floor and the first and second rollers such that an upper portion of the belt passes over the floor and a lower portion of the belt extends below the floor; a motor coupled to the first roller for rotating the first roller and causing travel of the belt; a drive shaft having first and second splined ends, the first splined end being operably connected to the motor; and a splined shaft operably connected to the motor; and a mounting collar having a first portion for mounting to the first roller, the first portion being shaped to correspond to the shape of the central passage of the first roller, and a second portion defining a spline for mounting to the splined shaft.

Various modifications and adaptations of the trailer are possible. For example, although not shown, either the first or second roller may be operably connected to the drive mechanism 55. The drive mechanism 55 may be configured to move the belt 46 in either direction (e.g. forwards or backwards), or in both directions allowing an operator to reverse the direction of the belt 46 if desired. Further, the tensioning mechanism 52 may be operably connected to either the first or second roller irrespective of which roller the drive mechanism 55 is connected to. Typically, the drive mechanism 55 and tensioning mechanism 52 are connected to different rollers for convenience of design.

Changes in the support and bracing of the load supporting floor as well the construction of the floor may also be made according to the desired impact tolerance of the floor, the type of load to be carried by the trailer, and the method of loading and unloading. In some embodiments, the extensible cylinders may be independently controllable providing the ability to adjust the respective ends of the second roller to guide/track the belt 46 about its respective ends. In such cases, the cylinders may be implemented in an automatic tensioning system similar to that described above.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A trailer for a truck or tractor, comprising:
a support frame;
a load supporting floor having opposed first and second ends, the floor being disposed above the support frame;
a pair of opposed sidewalls extending upwardly from lateral sides of the floor;
a first roller positioned towards the first end of the floor;
a second roller positioned towards the second end of the floor;
an endless belt extending about the floor and the first and second rollers such that an upper portion of the belt passes over the floor and a lower portion of the belt extends below the floor, the belt having sufficient elasticity to frictionally engage the first and second rollers;
a drive mechanism coupled to the first roller for rotating the first roller and causing travel of the belt; and
a tensioning mechanism for maintaining a relatively constant belt tension during travel of the belt, the tensioning mechanism being operably connected between one of the first or second rollers and the support frame to move the one first or second roller relative to the other of the first or second rollers so as to adjust the tension of the belt.

2. The trailer as claimed in claim 1, wherein the tensioning mechanism is operably connected between the second roller and the support frame to move the second roller relative to the first roller so as to adjust the tension of the belt.

3. The trailer as claimed in claim 2, further comprising first guide means for holding the lower belt portion relatively flat as it approaches the second roller.

4. The trailer as claimed in claim 2, further comprising a first guide mechanism positioned towards the second roller, the first guide mechanism including an upper portion extending inwardly from lateral side portions of the support frame and positioned above the lower belt portion for holding the lower belt portion relatively flat as it approaches the second roller.

5. The trailer as claimed in claim 2, further comprising a first guide mechanism positioned towards the second roller, the first guide mechanism including upper and lower portions extending inwardly from lateral side portions of the support frame, the belt extending between the upper and lower portions whereby the belt is held relatively flat as it approaches the second roller.

6. The trailer as claimed in claim 2, further comprising a first guide mechanism positioned towards the second roller, the first guide mechanism including a pair of horizontally spaced apart first members extending between lateral side portions of the support frame and a second member extending between lateral side portions of the support frame, the first members being positioned on one side of the lower belt portion, the second member being positioned on the other side of the lower belt portion.

7. The trailer as claimed in claim 6, wherein the first guide mechanism is operably connected to the tensioning mechanism or second roller to move the first guide mechanism relative to the first roller such that a relatively constant distance is maintained between the second roller and the first guide mechanism.

8. The trailer as claimed in claim 6, wherein the second member is horizontally positioned between the first members.

9. The trailer as claimed in claim 3, further comprising second guide means for holding the upper belt portion relatively flat as it approaches the first roller.

10. The trailer as claimed in claim 4, further comprising a second guide mechanism positioned towards the first roller, the second guide mechanism including a first portion extending inwardly from lateral side portions of the support frame and positioned above the upper belt portion for holding it in contact with the floor.

11. The trailer as claimed in claim 10, wherein the second guide mechanism further includes a second portion positioned opposite an edge of the belt

12. The trailer as claimed in claim 2, further comprising a pair of guard plates positioned at opposite ends of the first roller.

13. The trailer as claimed in claim 2, further comprising a mounting plate for mounting the drive mechanism to lateral sides of the support frame, wherein one or more adjustable tracking plates is positioned between the mounting plate and the support frame to provide selective adjustment of the positioned of the first roller.

14. The trailer as claimed in claim 13, wherein the adjustable tracking plates are removable.

15. The trailer as claimed in claim 2, wherein the tensioning mechanism is responsive to an operating stretch of the belt.

16. The trailer as claimed in claim 2, wherein the tensioning mechanism comprises a pair of extensible cylinders, each cylinder operably connected between the second roller and a lateral side portion of the support frame.

17. The trailer as claimed in claim 16, wherein the floor extends in a generally horizontal direction and the cylinders are mounted to the support frame to extend and retract in a generally horizontal direction generally parallel to the direction of the floor.

18. The trailer as claimed in claim 16, wherein the cylinders are hydraulic cylinders and the drive mechanism comprises a hydraulic motor operably connected to the first roller for rotating the first roller and causing travel of the belt.

19. The trailer as claimed in claim 18, wherein the hydraulic cylinders and the hydraulic motor are coupled to a common source of hydraulic fluid so as to provide automatic adjustment of the tension of the belt as the pressure of the hydraulic fluid delivered to the hydraulic motor to rotate the first roller increases and decreases.

20. The trailer as claimed in claim 18, wherein the hydraulic cylinders and the hydraulic motor are operably connected to a hydraulic system providing a common source of hydraulic fluid, the hydraulic cylinders extending and retracting in response to corresponding increases and deceases in the pressure of the hydraulic fluid delivered to the hydraulic motor.

21. The trailer as claimed in claim 18, wherein the hydraulic cylinders are operably coupled to a hydraulic accumulator or hydraulic intensifier.

22. The trailer as claimed in claim 16, wherein the cylinders are hydraulic or pneumatic cylinders maintained at a relatively constant pressure.

23. The trailer as claimed in claim 2, wherein the drive mechanism comprises:
a motor operably connected to the first roller for rotating the first roller and causing travel of the belt; and
an idler roller positioned opposite the first roller such that the belt extends about the first roller and the idler roller to provide a contact area between the belt and the first roller for reducing slippage of the belt.

24. The trailer as claimed in claim 23, wherein the idler roller is positioned such that the contact area between the belt and the first roller is greater than 50 percent of an outer surface of the first roller.

25. The trailer as claimed in claim 23, wherein the idler roller is positioned such that the contact area between the belt and first roller is at least 70 percent of an outer surface of the first roller.

26. The trailer as claimed in claim 2, wherein the first roller defines a central passage therethrough, the drive mechanism comprising:
a motor;
a drive shaft having first and second splined ends, the first splined end being operably connected to the motor; and
a mounting collar having a first portion for mounting to the first roller, the first portion being shaped to correspond to the shape of the central passage of the first roller, and a second portion defining a splined portion for mounting to the second splined end.

27. The trailer as claimed in claim 26, wherein the central passage of the first roller has a polylateral shaped cross-section, the first portion of the mounting collar having a corresponding polylateral shaped cross-section.

28. The trailer as claimed in claim 2, further comprising a torque intensifier operably coupled between the drive mechanism and the first roller for increasing the torque applied to the first roller.

29. The trailer as claimed in claim 28, wherein the torque intensifier is a planetary reduction drive.

30. The trailer as claimed in claim 2, wherein the second roller comprises a shaft extending through an axis of rotation of the second roller, and a plurality of fins extending radially from the shaft, the belt extending peripherally about ends of the fins.

31. A trailer for a truck or tractor, comprising:
a support frame;
a load supporting floor having opposed first and second ends, the floor being disposed above the support frame;
a pair of opposed sidewalls extending upwardly from lateral sides of the floor;
a first roller positioned towards the first end of the floor and a second roller positioned towards the second end of the floor;
an endless belt extending about the floor and the first and second rollers such that an upper portion of the belt passes over the floor and a lower portion of the belt extends below the floor, the belt having sufficient elasticity to frictionally engage the first and second rollers;
a drive mechanism coupled to the first roller for rotating the first roller and causing travel of the belt; and
a pair of extensible cylinders, each cylinder operably connected between the second roller and a lateral side portion of the support frame for moving the second roller relative to the first roller along an axis generally parallel to a direction of the floor so as to adjust the tension of the belt.

32. A trailer for a truck or tractor, comprising:
a support frame;
a load supporting floor having opposed first and second ends, the floor being disposed above the support frame;
a pair of opposed sidewalls extending upwardly from lateral sides of the floor;
a first roller positioned towards the first end of the floor and a second roller positioned towards the second end of the floor;
an endless belt extending about the floor and the first and second rollers such that an upper portion of the belt passes over the floor and a lower portion of the belt extends below the floor, the belt having sufficient elasticity to frictionally engage the first and second rollers;
a drive mechanism operably connected to the first roller for rotating the first roller and causing travel of the belt; and
an idler roller positioned opposite the first roller such that the belt wraps around the first roller and the idler roller to provide a contact area between the belt and the first roller for reducing slippage of the belt.
